(19) United States
(12) Patent Application Publication
(10) Pub. No.: US 2017/0348840 A1
(43) Pub. Date: Dec. 7, 2017

(54) DRIVE-IN DEVICE WITH ADJUSTABLE COMBUSTION CHAMBER

(71) Applicant: HILTI AKTIENGESELLSCHAFT, Schaan (LI)

(72) Inventors: Markus WOERNER, Hergensweiler (DE); Thomas SPERRFECTER, Grüsch (CH); Peter STAUSS-REINER, Feldkirch (AT)

(21) Appl. No.: 15/536,008

(22) PCT Filed: Dec. 15, 2015
(86) PCT No.: PCT/EP2015/079728

§ 371 Date: Jun. 14, 2017

(30) Foreign Application Priority Data
Dec. 19, 2014 (EP) 14199196.8

(51) Int. Cl. B25C 1/08; B25C 1/00

(52) U.S. Cl. CPC B25C 1/08; B25C 1/008

(57) ABSTRACT

The invention relates to a drive-in device, comprising a drive-in piston which is guided in a cylinder for driving a nail element into a workpiece and comprising a combustion chamber which is arranged over the drive-in piston and which can be filled with a combustion gas, said combustion chamber comprising a cylindrical portion which is symmetrical about a central axis (A). A movable combustion chamber wall of the combustion chamber can be adjusted along the central axis (A), and a spring is supported between the movable combustion chamber wall and a housing. A force vector (F) of the spring has a lateral offset (V) with respect to the central axis (A).

The invention refers to a drive-in device, in particular a handheld drive-in device, according to the preamble of claim 1.

DE 102 26 878 A1 describes a drive-in device for driving a nail into a workpiece, wherein a combustion chamber is filled with a combustion gas, wherein after an ignition process, a drive-in piston is accelerated against the nail. The combustion chamber has a movable combustion chamber wall, wherein an adjusting rod is guided via a passage through a housing of the combustion chamber and is connected to the movable combustion chamber wall. The movable combustion chamber wall is subject to a force exerted by a spring in the axial direction, wherein the force vector of the spring force coincides with a central axis of the combustion chamber.

The object of the invention is to provide a drive-in device, which allows a particularly reliable operation.

This object is achieved for said drive-in device, according to the invention, by the characterizing part of claim 1. Due to the eccentric arrangement of the spring or force vector of spring, a reduction of the maximum tilting moment of the movable combustion chamber wall about a radial axis is possible. In this way, the displacement of the bottom is generally smoother and the risk of blocking in connection with further influences (soiling, icing, etc.) is reduced.

The movable combustion chamber wall generally allows the collapsing of the combustion chamber, for example, as part of a safety arrangement, when the device is not correctly positioned on the workpiece. In such devices, the combustion chamber is tensioned before each setting operation through its placement, so that each time a slipping over of the fixed combustion chamber wall takes place.

The spring between the movable combustion chamber wall and the housing pushes the movable combustion chamber wall in the drive-in direction, so that in case of absence of corresponding reaction forces, the combustion chamber is collapsed. The force vector of the spring is to be construed as a vector whose length, direction and point of application correspond to the action of the spring upon the bottom. In previously known constructive solutions, the force vector acts in the center of the bottom or extends along the central axis of the combustion chamber.

Unfavorable tilting moments acting upon the movable combustion chamber wall may have various origins. In particular, the tilting moments may be caused by an adjustment mechanism acting upon the bottom. Moreover, the movable combustion chamber wall may also be subject to a moment caused by a targeted pressure acting on spring loaded elements. Such an element may be a gas valve, a safety switch or similar, for example. Also, a pressure acting on a resetting swirl plate may exert a tilting moment on the bottom. In general, the positioning of the spring or force vectors is advantageously selected so that the influence of all moments on the movable combustion chamber wall may be optimally compensated.

In a preferred embodiment of the invention, the offset is at least equal to one tenth of the radius of the movable combustion chamber wall. In particular, it is preferred that the offset is at least one fifth of the radius of the movable combustion chamber wall. In this way, very large tilting moments may be compensated.

In a generally preferred embodiment of the invention, a mounting element, which is spring loaded and may be pushed in the direction of the central axis, is positioned on the drive-in device, wherein the mounting element is connected to the adjustable bottom by means of a linkage. Such a mounting element is used as a reliable safety device during operation of the drive-in device. The mounting device may be provided, for example, as a sleeve, which is concentrically arranged with respect to the central axis of the device. As an alternative, it may also be provided in the form of a suspended element, which is laterally offset with respect to the central axis.

In a preferred detailed embodiment, the linkage is force decoupled in a direction perpendicular to the central axis. This allows a particularly flexible construction of the mounting element. It also allows the mounting element to remain fixed on the underlying surface in case of recoil of the device during a setting procedure and improves the quality of attachment. In particular, it is foreseen that the point of transmission of force is positioned near the force decoupling essentially in line with the force vector of the spring. A force decoupling is to be construed, in the present case, as a situation in which in at least one plane between an anterior point of application of the mounting element and the adjustable bottom a separation of linkage is such that in the direction perpendicular to the central axis no transmission of forces takes place. This generally affects the tilting moment, which is exerted by the linkage on the bottom. In particular, it follows that the force which is transmitted by the mounting sleeve, which is symmetrical to the central axis, by means of the linkage, on the bottom, gives rise to moments with respect to the central axis. The resulting moment may be ideally compensated, in the sense of the present invention, through the eccentrically positioned spring.

In order to achieve a space saving construction it is preferred that the linkage comprises only one movable adjusting rod, which passes through a passage in the combustion chamber and which is connected to the adjustable bottom. It may then be arranged sot that it does not negatively affect the general dimensions of the device. In this way, the access of the device into tight compartments is ensured. In such an embodiment, the inventive compensation of moments is particularly advantageous, since it is also possible to avoid a tilting of the adjusting rod inside the passage.

Further advantages and characteristics of the invention may be obtained from the following exemplary embodiment as well as from the dependent claims.

In the following, a preferred exemplary embodiment of the invention is described and explained in detail by means of the attached drawings.

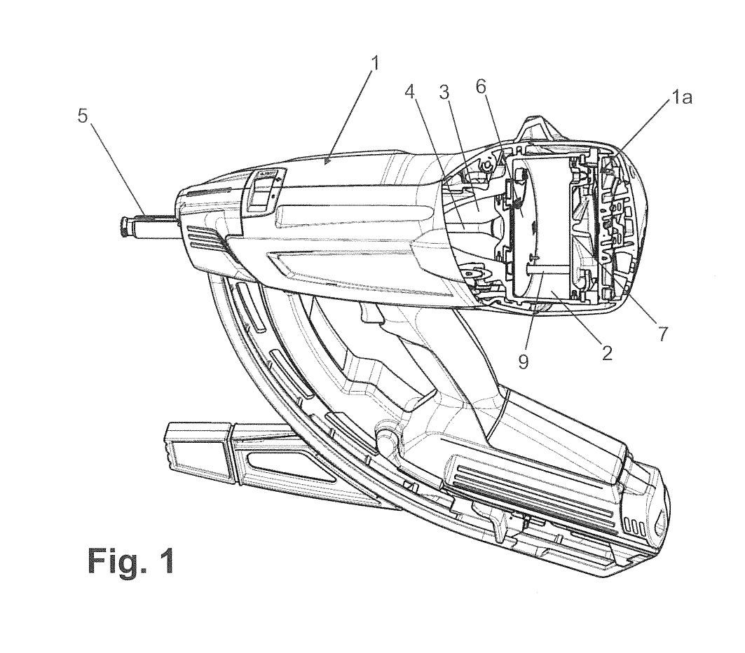

FIG. 1 shows a spatial global view of a drive-in device according to the invention with a section of the combustion chamber,

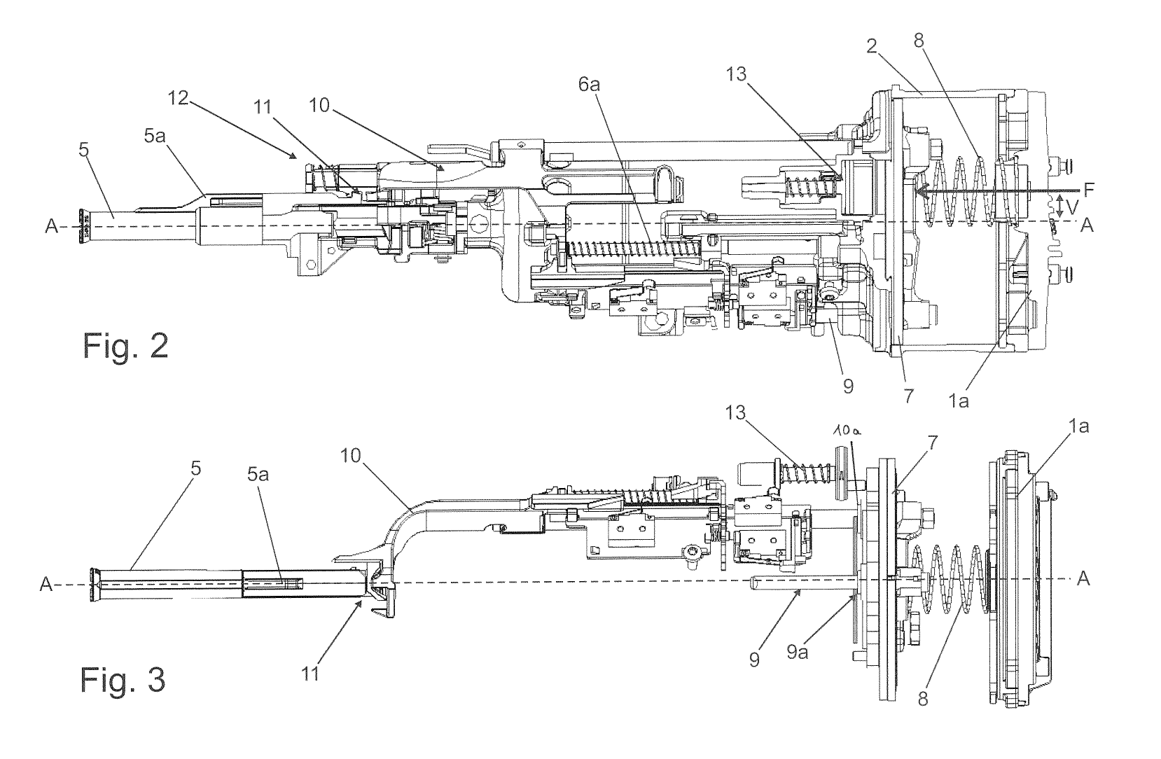

FIG. 2 shows a top view of components of the device of FIG. 1 from the side,

FIG. 3 shows a top view of components of the device of FIG. 1 from above,

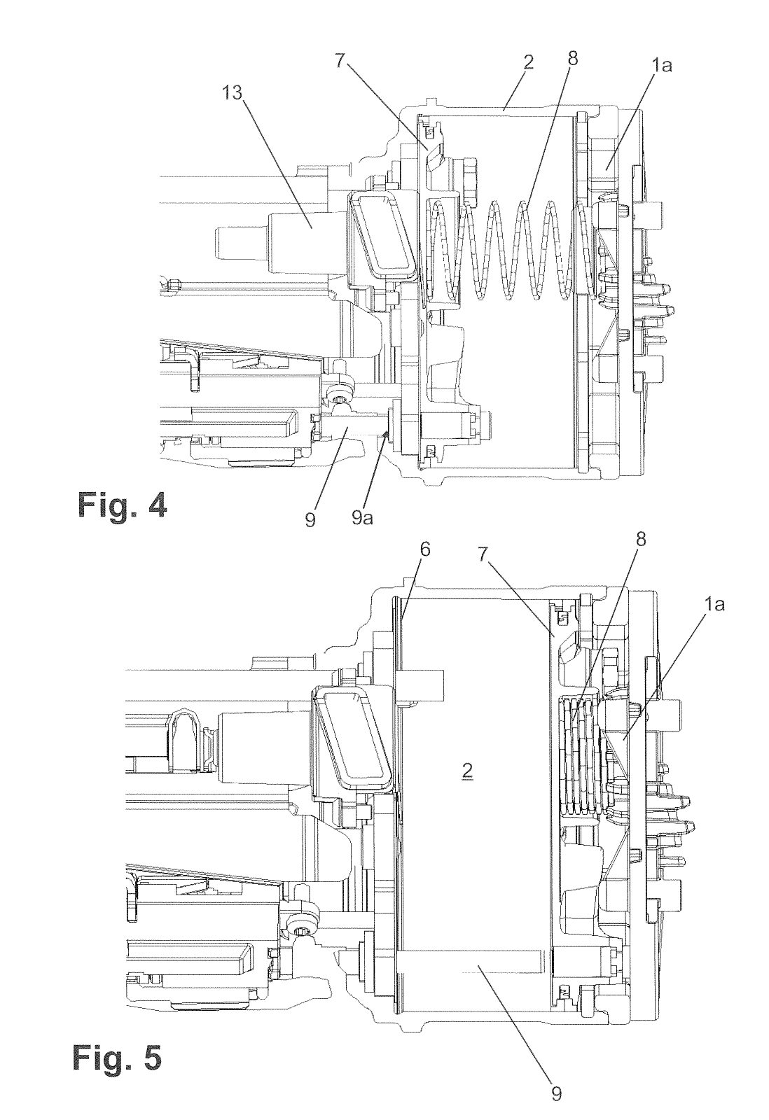

FIG. 4 shows a sectional view of the combustion chamber of the device of FIG. 1 from the side, in a collapsed state,

FIG. 5 shows a sectional view of the combustion chamber of the device of FIG. 1 from the side, in a tensioned state.

The drive-in device of FIG. 1 is a handheld device, comprising a housing 1 and a combustion chamber 2 which is contained in the same, with a partially cylindrical combustion chamber wall. The combustion chamber 2 is adjoined by a cylinder 3 with a drive-in piston 4 which is guided in the same.

A safety mechanism of device comprises a mounting element provided by a mounting sleeve 5, which is mounted on a workpiece (not shown) and which is pushed against the pressure of a spring 8. Only in this state, the drive-in process may be activated by ignition of a combustion gas in the combustion chamber 2.

A swirl plate 6 is also arranged in the combustion chamber, which may be moved before an ignition by an adjusting rod 6a through the combustion chamber 2.

A movable combustion chamber wall 7 of the combustion chamber 2 is movable along an axis A coinciding with the drive-in direction, so that the volume of the combustion chamber is variable. The bottom 7 rests, to this end, with the spring 8, against a rear wall la of the outer housing 1. The spring 8 applies a force vector F upon the movable combustion chamber wall 7. The spring 8, which is a helical spring, is not concentric with respect to the axis A. The force vector F of spring 8 is parallel to axis A, although it radially acts, with an offset V with respect to central axis A, on the movable combustion chamber wall 7. The value of offset V in this case is equal to about 23% of the radius of movable combustion chamber wall 7 or combustion chamber 2.

The length of force vector F varies according to the respective tension of spring 8. The force vector F does not run beside the combustion chamber, but overlaps instead the cross section of combustion chamber 2 in the plane perpendicular to the central axis. The spring 8 rests directly against the rear side of the movable combustion chamber wall 7.

The movable combustion chamber wall 7 may be moved through the linkage 10 in the direction of axis, wherein both the linkage 10 and the adjusting rod 9 pass through a passage 10a or 9a in a second anterior bottom of the combustion chamber. The pushing in of the mounting sleeve 5 acts upon the linkage 10, which in turn displaces the movable combustion chamber wall 7 against the force of spring 8. In this way, a volume sufficient for ignition is formed in the combustion chamber. The linkage 10 and the adjusting rod 9 inside the combustion chamber run parallel to axis A, although laterally offset. The linkage 10 and the adjusting rod 9 are also laterally offset with respect to force vector F.

The adjusting rod 9 is part of the pressing system, which is connected from the movable combustion chamber wall 7 to the linkage 10, which in turn is connected to the mounting element. The mounting element 5 has a sleeve-like shape near its application point on the workpiece, and is concentric with respect to axis A. An integrally formed extension 5a laterally protrudes and supports the mounting element 5 in a force transmission point 11 against the linkage 10. In this force transmission point 11, a force of the mounting sleeve is transmitted, on one hand, only in a direction parallel to the central axis, and on the other hand, only in a direction towards the linkage. A clearance is present in the perpendicular direction in the force transmission point 11, so that in these directions, a force decoupling is present. The further linkage 10 has no force decoupling, and therefore transmits also moments.

The decoupling in the force transmission point 11 in particular allows the bolt guide to remain on the workpiece when the device recoils due to combustion. It also facilitates a simple construction of an adjusting element 12 in the area of the mounting element 5. By means of the adjusting element 12, the striking depth of the mounting element 5 may be adjusted.

In order to simplify the illustration, parts of linkage 10 are not shown in drawings. In particular, the adjusting rod 9 is connected to the bottom 7 in a torque-fixed way. The linkage 10 is connected, in turn, in a torque-fixed way, to the bottom 7. In order to have a low-torque support of the movable combustion chamber wall 7 by the spring 8 or the force vector F, the force vector is approximately or essentially positioned on a line with the force transmission point 11, which is parallel to the central axis.

In order to further reduce a maximum tilting moment acting on the movable combustion chamber wall 7, the position of the force vector F or spring 8 may also be finely tuned. This is performed considering further forces, which exert a moment on the movable combustion chamber wall 7.

Such further forces may be generated, for example, by an inlet and outlet valve 13, which is mechanically connected to the movable combustion chamber wall 7, a safety switch (not shown) or the spring of the swirl plate 6, which is preloaded by the linkage 10.

Normally, the various forces which generate a tilting moment on the movable combustion chamber wall 7, depend on the position of the movable combustion chamber wall 7 or on the respective operating condition. Therefore, in general, it is not always possible to obtain a complete compensation of all moments. In the invention, the position of the force vector F may however be selected so that the maximum tilting moments acting on the bottom are reduced during operation. In this way, a locking or friction of the movable combustion chamber wall 7 during its adjustment may be effectively reduced.

1. A drive-in device, comprising a housing having a rear wall; a drive-in piston which is guided in a cylinder for driving a nail element into a workpiece; and a combustion chamber which is arranged over the drive-in piston and which can be filled with a combustion gas; the combustion chamber comprising a cylindrical portion which is symmetrical about a central axis (A), and a movable combustion chamber wall; wherein the movable combustion chamber wall of the combustion chamber can be adjusted along the central axis (A); and, a spring supported between the movable combustion chamber wall and the rear wall of the housing; the spring having a force vector (F) having a lateral offset (V) with respect to the central axis (A).

2. The drive-in device of claim 1, wherein the movable combustion chamber wall has a radius and the lateral offset (V) is at least equal to one tenth of the radius of the movable combustion chamber wall.

3. The drive-in device of claim 1, further comprising a mounting element, which is spring loaded and can be pushed in a direction of the central axis (A), arranged on the drive-in device, wherein the mounting element is connected to the movable combustion chamber wall by a linkage.

4. The drive-in device of claim 3, wherein the linkage is force decoupled in a direction perpendicular to the central axis (A).

5. The drive-in device of claim 4, wherein a force transmission point near the force decoupling is essentially arranged in line with the force vector (F) of the spring.

6. The drive-in device of claim 3, wherein the linkage comprises a movable adjusting rod, which passes through a passage in the combustion chamber and which is connected to the movable combustion chamber wall.

7. The drive-in device of claim 2, further comprising a mounting element, which is spring loaded and can be pushed in a direction of the central axis (A), arranged on the drive-in device, wherein the mounting element is connected to the movable combustion chamber wall by a linkage.

8. The drive-in device of claim 7, wherein the linkage is force decoupled in a direction perpendicular to the central axis (A).

9. The drive-in device of claim 8, wherein a force transmission point near the force decoupling is essentially arranged in line with the force vector (F) of the spring.

10. The drive-in device of claim 4, wherein the linkage comprises a movable adjusting rod, which passes through a passage in the combustion chamber and which is connected to the movable combustion chamber wall.

11. The drive-in device of claim 5, wherein the linkage comprises a movable adjusting rod, which passes through a passage in the combustion chamber and which is connected to the movable combustion chamber wall.

12. The drive-in device of claim 8, wherein the linkage comprises a movable adjusting rod, which passes through a passage in the combustion chamber and which is connected to the movable combustion chamber wall.

13. The drive-in device of claim 9, wherein the linkage comprises a movable adjusting rod, which passes through a passage in the combustion chamber and which is connected to the movable combustion chamber wall.
